(19) United States
(12) Patent Application Publication
(10) Pub. No.: US 2025/0133535 A1
(43) Pub. Date: Apr. 24, 2025

(54) MANAGING PAGING FOR DIFFERENT SERVICES

(71) Applicant: GOOGLE LLC, Mountain View, CA (US)

(72) Inventor: Chih-Hsiang Wu, Taoyuan City (TW)

(21) Appl. No.: 18/681,503

(22) PCT Filed: Aug. 5, 2022
(86) PCT No.: PCT/US2022/039645

§ 371 Date: Feb. 5, 2024

Related U.S. Application Data
(60) Provisional application No. 63/203,994, filed on Aug. 5, 2021.

(51) Int. Cl. H04W 68/00; H04W 68/02; H04W 88/08

(52) U.S. Cl. CPC H04W 68/005; H04W 68/02; H04W 88/085

(57) ABSTRACT

A method for paging a UE is implemented in a distributed unit (DU) of a distributed base station. The method includes receiving, by processing hardware from a central unit (CU) of the distributed base station and when the UE is not operating in a connected state of a protocol associated with controlling radio resources, a CU-to-DU message related to the UE and indicating a voice call; and transmitting, by the processing hardware to the UE via a radio interface, a paging message including an indication of the voice call.

### FIELD OF THE DISCLOSURE

This disclosure relates generally to wireless communications and, more particularly, to paging a user equipment (UE) for one or more services when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures.

In some scenarios, a UE can operate in a state in which a radio resource control connection with the RAN is not active (e.g., RRC_IDLE or RRC_INACTIVE state) and subsequently transition to the connected state. Generally speaking, in the inactive state, the radio connection between the UE and the radio access network (RAN) is suspended. Later, when the UE is triggered to send data (e.g., outgoing phone call, browser launch) or receives a paging message from the base station, the UE can then transition to the connected state. To carry out the transition, the UE can request that the base station establish a radio connection (e.g., by sending an RRC Setup Request message to the base station) or resume the suspended radio connection (e.g., by sending an RRC Resume Request message to the base station), so that the base station can configure the UE to operate in the connected state.

A UE equipped with multiple SIMs, or a “multi-SIM UE,” can be connected to a first core network (CN). When operating in idle or inactive RRC state, the UE must still check for paging messages that may arrive from the second CN as well as check for paging messages that may arrive from the first CN. If the second CN pages the UE, the UE maintains a connection with the first CN while starting a new active connection with the second CN.

However, implementing this paging procedure presents several challenges. For example, a 5G NR radio access network (i.e., the NG-RAN) or a 4G LTE network (i.e., the E-UTRAN) may include distributed base stations, where each distributed base station includes a central unit (CU) and at least one distributed unit (DU). It is not clear how a network (i.e., a core network, a CU and a DU) sends a paging cause to the UE via a distributed base station.

### SUMMARY

Generally speaking, the techniques of this disclosure allow one or more of the CN, a CU of a distributed base station, and/or a DU of distributed base station to determine when a paging message for a UE should include an indication of voice, e.g., of a data packet associated with a voice call. Without this indication, the UE may not always correctly determine the UE should disconnect from one core network when receiving a paging message from another core network

### BRIEF DESCRIPTION OF THE DRAWINGS

FIG. 1A is a block diagram of an example wireless communication system in which a user device and a base station of this disclosure can implement the techniques of this disclosure for managing enhanced paging;

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A illustrates an example scenario in which a CN determines to include an indication of a voice call in a CN-to-BS message to a distributed base station, the CU of the distributed base station determines to provide an indication of the voice call in the CU-to-DU message, and the DU transmits a paging message including a voice indication, to a UE operating in an idle state;

FIG. 3B illustrates a scenario similar to that of FIG. 3A, but with the CU formatting the paging message rather than the DU;

FIG. 3C illustrates a scenario similar to that of FIG. 3A, but with the UE operating in an inactive state;

FIG. 3D illustrates a scenario similar to that of FIG. 3B, but with the UE operating in an inactive state;

FIG. 3E illustrates a scenario generally similar to that of FIGS. 3A-3D, but with the UE initiating redirection to a less advanced core network;

FIG. 4A illustrates a scenario similar to that of FIG. 3A, but the CU forwarding a circuit-switched (CS) domain indicator to indicate a voice call;

FIG. 4B illustrates a scenario similar to that of FIG. 4A, but with the CU formatting the paging message rather than the DU;

FIG. 5A is a flow diagram of an example method for generating a CN-to-BS message related to a UE, in view of whether downlink data for the UE is received from an IMS network, which can be implemented in a CN of FIG. 1A;

FIG. 5B is a flow diagram of an example method for generating a CN-to-BS message for a UE, in view of whether downlink data for the UE is received over a particular tunnel, which can be implemented in a CN of FIG. 1A;

FIG. 6A is a flow diagram of an example method for generating a CN-to-BS message for a UE, in view of whether the UE is attached to another CN, which can be implemented in a CN of FIG. 1A;

FIG. 6B is a flow diagram of an example method for generating a CN-to-BS message for a UE, in view of whether the UE supports a voice indication in a paging message, which can be implemented in a CN of FIG. 1A;

FIG. 6C is a flow diagram of an example method for generating a CN-to-BS message for a UE, in view of whether the base station supports a voice indication in a paging message, which can be implemented in a CN of FIG. 1A;

FIG. 7A is a flow diagram of an example method for generating a CU-to-DU message for a UE, in view of whether a CN-to-BS message indicates a particular service, which can be implemented in a CU of a distributed base station of FIG. 1A;

FIG. 7B is a flow diagram of an example method for generating a CU-to-DU message for a UE, in view of whether a BS-to-BS message includes a voice indication, which can be implemented in a CU of a distributed base station of FIG. 1A;

FIG. 8A is a flow diagram of an example method for generating a CU-to-DU message for a UE, in view of whether a data packet for the UE is received over a particular tunnel, which can be implemented in a CU of a distributed base station of FIG. 1A;

FIG. 8B is a flow diagram of an example method for generating a CU-to-DU message for a UE, in view of whether a data packet for the UE is associated with a particular flow, which can be implemented in a CU of a distributed base station of FIG. 1A;

FIG. 8C is a flow diagram of an example method for generating a CU-to-DU message for a UE, in view of whether the UE is attached to another CN, which can be implemented in a CU of a distributed base station of FIG. 1A;

FIG. 9A is a flow diagram of an example method for generating a BS-to-BS message for a UE, in view of whether a data packet for the UE is received over a particular tunnel, which can be implemented in a base station of FIG. 1A;

FIG. 9B is a flow diagram of an example method for generating a BS-to-BS message for a UE, in view of whether a data packet for the UE is associated with a particular flow, which can be implemented in a base station of FIG. 1A;

FIG. 9C is a flow diagram of an example method for generating a BS-to-BS message for a UE, in view of whether the UE is attached to another CN, which can be implemented in a base station of FIG. 1A;

FIG. 10A is a flow diagram of an example method for generating a paging message in view of whether a downlink data packet was received over a particular tunnel, which can be implemented in a base station of FIG. 1A;

FIG. 10B is a flow diagram of an example method for generating a paging message in view of whether a downlink data packet is associated with a particular flow, which can be implemented in a base station of FIG. 1A;

FIG. 10C is a flow diagram of an example method for generating a paging message in view of whether the UE is attached to another CN, which can be implemented in a base station of FIG. 1A;

FIG. 11A is a flow diagram of an example method for generating a message for a CU-CP, in view of whether a data packet for the UE is received over a particular tunnel, which can be implemented in a CU-UP of a distributed base station of FIG. 1A;

FIG. 11B is a flow diagram of an example method for generating a message for a CU-CP, in view of whether a data packet for the UE is associated with a particular flow, which can be implemented in a CU-UP of a distributed base station of FIG. 1A;

FIG. 11C is a flow diagram of an example method for generating a message for a CU-CP, in view of whether the UE is attached to another CN, which can be implemented in a CU-UP of a distributed base station of FIG. 1A;

FIG. 12 is a flow diagram of an example method for generating a CU-to-DU message for a UE, in view of whether a downlink message for the UE includes a voice indication, which can be implemented in a CU-CP of a distributed base station of FIG. 1A;

FIG. 13 is a flow diagram of an example method for changing the format of a voice indication, which can be implemented in a DU of a distributed base station of FIG. 1A;

FIG. 14 is a flow diagram of another example method for changing the format of a voice indication, which can be implemented in a DU of a distributed base station of FIG. 1A;

FIG. 15 is a flow diagram of an example method for receiving a paging message in accordance with a UE-specified capability, which can be implemented in the UE of FIG. 1A;

FIG. 16 is a flow diagram of another example method for receiving a paging message in accordance with a UE-specified capability, which can be implemented in the UE of FIG. 1A;

FIG. 17 is a flow diagram of an example method for indicating capability of a UE to the CN, with respect to voice indication, which can be implemented in the UE of FIG. 1A;

FIG. 18 is a flow diagram of an example method for indicating, to one CN, that the UE is temporarily unable to communicate with a second CN, which can be implemented in the UE of FIG. 1A;

FIG. 19 is a flow diagram of an example method for restricting paging of a UE, which can be implemented a CN of FIG. 1A; and

FIG. 20 is a flow diagram of another example method for restricting paging of a UE, which can be implemented a CN of FIG. 1A.

### DETAILED DESCRIPTION OF THE DRAWINGS

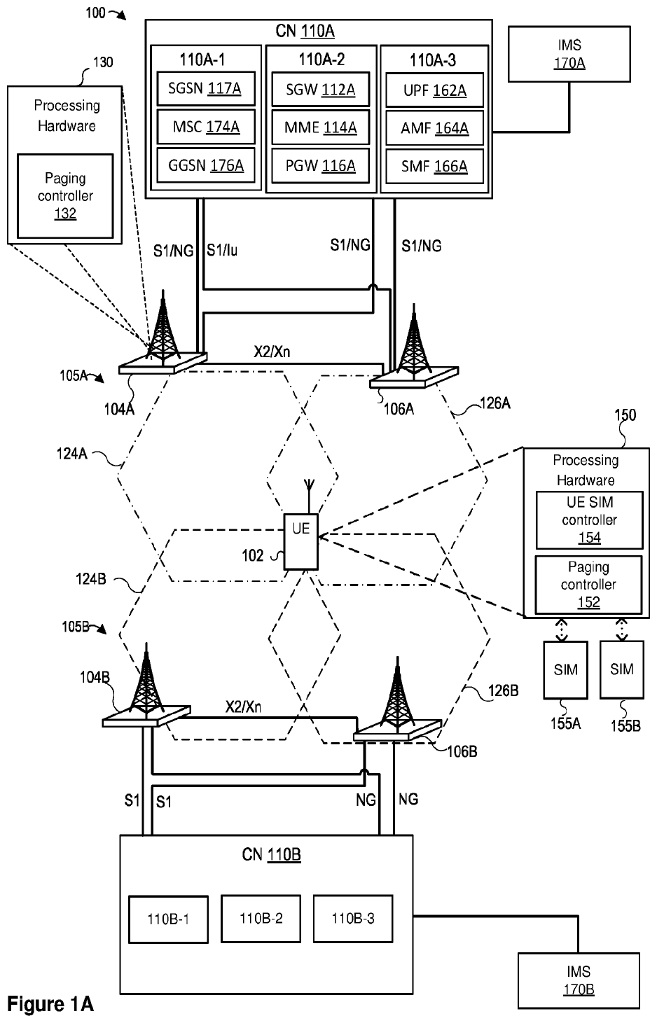

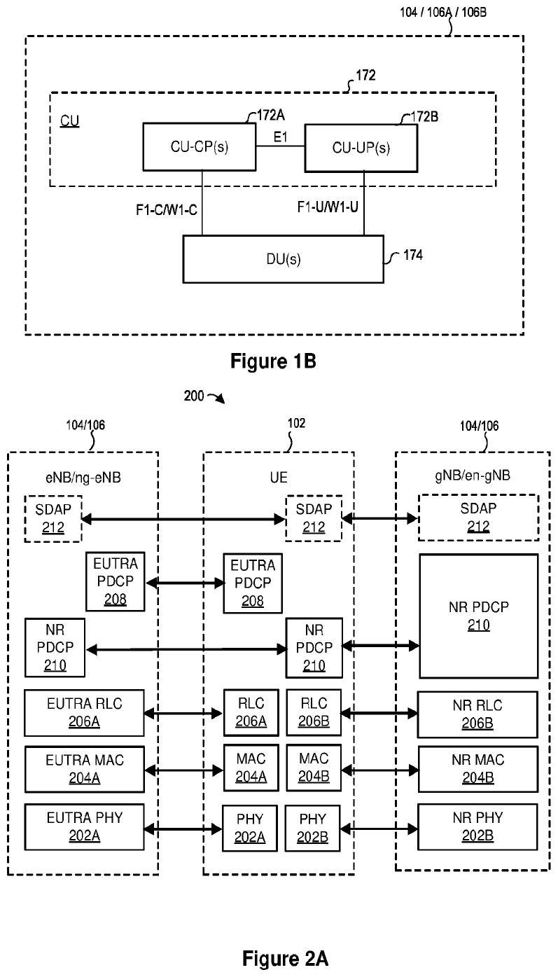

Referring first to FIG. 1A, an example wireless communication system 100 includes a UE 102, base stations 104A, 104B, 106A, and 106B, a core network (CN) 110A, and a CN 110B. The base stations 104A-B and 106A-B can operate in respective radio access networks (RANs) 105A and 105B connected to the CNs 110A and 110B, respectively.

The base station 104A supports a cell 124A, and the base station 106A supports a cell 126A. The cells 124A and 126A can partially overlap, so that the UE 102 can select, reselect or hand over from one of the cells 124 or 126 to another cell. If the base station 104A is a gNB, the cell 124A is a New Radio (NR) cell. If the base station 104A is an ng-eNB, the cell 124A is an evolved universal terrestrial radio access (E-UTRA) cell. Similarly, if the base station 106A is a gNB, the cell 126A is an NR cell, and if the base station 106A is an ng-eNB, the cell 126A is an E-UTRA cell. The cells 124A and 126A can be in the same Radio Access Network Notification Areas (RNA) or different RNAs. In general, the RAN 105A or RAN 105B can include any number of base stations, and each of the base stations can cover one, two, three, or any other suitable number of cells.

The UE 102 can support at least a 5G NR (or simply, “NR”) or E-UTRA air interface to communicate with the base stations 104A-B or 106A-B. Each of the base stations 104A-B, 106A-B can connect to the CN 110A or CN 110B via an appropriate interface (e.g., S1 or NG interface). The base stations 104A, 104B and 106A, 106B also can be interconnected via respective interfaces (e.g., X2 or Xn interfaces) for interconnecting NG RAN nodes. The base station 104A, 104B and 106A, 106B can directly exchange messages or information over the X2 or Xn interface. In general, each of the CN 110A and CN 110B can connect to any suitable number of base stations supporting NR cells and/or EUTRA cells.

The CN 110A can be a GPRS (3G) core 110A-1, an evolved packet core (EPC) 110A-2, or a fifth-generation core (5GC) 110A-3, all of which are depicted in FIG. 1A. The GPRS core 110A-1 can include a Serving GPRS Support Node (SGSN) 117A, a mobile switching center (MSC) 174A, and a GPRS Gateway Serving Node (GGSSN) 176A. Among other components, the EPC 110A-2 can include a Serving Gateway (SGW) 112A, a Mobility Management Entity (MME) 114A, and a Packet Data Network Gateway (PGW) 116A. The SGW 112A in general is configured to transfer user-plane packets related to audio calls, video calls, Internet traffic, etc., and the MME 114A is configured to manage authentication, registration, paging, and other related functions. The PGW 116A provides connectivity from the UE to one or more external packet data networks, e.g., an Internet network and/or an Internet Protocol (IP) Multimedia Subsystem (IMS) network 170A. The 5GC 110A-3 includes a User Plane Function (UPF) 162 and an Access and Mobility Management (AMF) 164A, and/or Session Management Function (SMF) 166A. Generally speaking, the UPF 162A is configured to transfer user-plane packets related to audio calls, video calls, Internet traffic, etc., the AMF 164A is configured to manage authentication, registration, paging, and other related functions, and the SMF 166A is configured to manage PDU sessions. The CN 110B can have a similar implementation with a core 110B-1, 110B-2, or 110B-3 and analogous components.

The CN 110A may determine to page the UE 102 if the CN receives downlink (DL) data for the UE 102 when a radio connection between the UE and the RAN 105 is not active (e.g., when the UE operates in an idle or an inactive state associated with a protocol for controlling radio resources, such as RRC_IDLE or RRC_INACTIVE).

In cases in which the UE operates in an idle state (e.g., RRC_IDLE or CM-IDLE), the CN 110A determines to page the UE 102 in order to send the DL data to the UE 102. In response to the determination, the CN 110A can perform paging operations with the RAN 105 to page the UE 102 operating in the idle state. More specifically, the CN 110A can send a CN-to-BS paging message (e.g., an NG application protocol (NGAP) Paging message as defined in 3GPP specification 38.413 or an S1 application protocol (S1AP) Paging message as defined in 3GPP specification 36.413) to the RAN 105A to trigger the RAN 105A to send a UE paging message to the UE 102. The CN 110A includes a CN ID of the UE 102 in the NGAP paging message. For example, the CN ID can be an S-TMSI or NG-5G-S-TMSI. In response to the CN-to-BS paging message, the base station 104 of the RAN 105 generates a UE paging message (e.g., RRC paging message defined in 3GPP specification 38.331) including the CN ID and sends the UE paging message via the cell 124 to page the UE 102. In cases that the base station 104A has additional cell(s), the base station 104A can also send the UE paging message via the additional cell(s) to page the UE 102. In response to or after receiving the UE paging message from the base station 104A, e.g., via the cell 124A, the UE 102 in the idle state can perform an RRC connection establishment procedure with the base station 104A to establish an RRC connection (i.e., SRB1 and/or SRB2) with the base station 104A and sends a Service Request message to the CN 110A via the base station 104 and the RRC connection (i.e., either the SRB1 or SRB2). After receiving the Service Request message, the CN 110A can send to the base station 104 a CN-to-BS message (e.g., PDU Session Resources Setup Request message or an Initial Context Setup Request message) to request the base station 104A to assign resources for the UE 102 to receive the DL data. The CN 110A can include a PDU Session ID and/or a Quality of Service (QoS) flow ID of the UE 102 in the CN-to-BS message to request the base station 104 to assign resources for a PDU Session and/or a QoS flow identified by the PDU Session ID and/or the QoS flow ID, respectively. In response to or after receiving the CN-to-BS message, the base station 104A activates security protection for the UE 102 and sets up a DRB for the PDU Session and/or QoS flow. The base station 104A can transmit to the UE 102 a security mode command message to activate the security protection, and the UE 102 can transmit a security mode complete message to the base station 104A in response. The base station 104A can transmit to the UE 102 an RRC reconfiguration message configuring the DRB for the PDU Session and/or QoS flow, and the UE 102 can transmit an RRC reconfiguration complete message to the base station 104A in response.

In cases in which the UE 102 operates in an inactive state (e.g., RRC_INACTIVE state), the CN 110A sends the DL data, e.g., via an NG-U connection or interface, to the RAN 105A without sending a CN-to-BS paging message (e.g., an NGAP Paging message as defined in 3GPP specification 38.413 or an S1AP Paging message as defined in 3GPP specification 36.413) for the UE 102 to the base station 104A. After or in response to receiving the DL data, the base station 104A generates a UE paging message (e.g., RRC paging message defined in 3GPP specification 38.331) including an RAN ID of the UE 102 and sends the UE paging message via the cell 124A to page the UE 102. In cases that the base station 104A has additional cell(s), the base station 104 can also send the UE paging message via the additional cell(s) to page the UE 102. For example, the RAN ID can be an inactive radio network temporary identifier (I-RNTI) or a resume ID. In some scenarios and implementations, the base station 104A can send to the base station 106A a BS-to-BS paging message (e.g., a Xn Paging message as defined in 3GPP specification 38.423 or a X2 Paging message as defined in 3GPP specification 36.423) including the RAN ID to trigger the base station 106 to page the UE 102. In response to or in accordance with the BS-to-BS paging message, the base station 106A generates a UE paging message including the RAN ID and transmits the UE paging message via the cell 126A. In cases that the base station 106A has additional cell(s), the base station 106A can also send the UE paging message via the additional cell(s) to page the UE 102. In response to or after receiving a UE paging from the base station 104, the UE 102 can perform an RRC connection resume procedure with the base station 104 to transition from the inactive state to a connected state (e.g., RRC_CONNECTED state).

The base station 104A is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a paging controller 132 configured to manage paging operations with one or more UEs operating in the RRC_INACTIVE or RRC_IDLE state. The processing hardware 130 can also include a Packet Data Convergence Protocol (PDCP) controller (not shown) configured to transmit PDCP PDUs in accordance with which the base station 104A can transmit data in the downlink direction, in some scenarios, and receive PDCP PDUs in accordance with which the base station 104A can receive data in the uplink direction, in other scenarios. The processing hardware further can include an RRC controller (not shown) to implement procedures and messaging at the RRC sublayer of the protocol communication stack. The base stations 106A, 104B, and 106B can include processing hardware generally similar to the processing hardware 130 of the base station 104A.

In FIG. 1A, the CN 110A is connected to the IMS 170A, and the CN 110B is connected to an IMS 170B. The CN 110A and 110B however can be connected to the same IMS, i.e., the IMS 170A and 170B in some implementations are the same IMS service.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a paging controller 152 configured to manage paging operations when the UE 102 operates in the RRC_IDLE or RRC_INACTIVE state. The processing hardware 150 can also include a UE SIM controller 154 configured to coordinate operation of multiple SIMs, e.g., SIM 155A and SIM 155B.

Because the UE 102 can be equipped with multiple SIMs for accessing both the CN 110A and the CN 110B, the UE 102 must be able to check for paging messages from the CN 110B when connected to the CN 110A, and conversely check for paging messages from the CN 110A when connected to the CN 110B. As discussed below, when a paging message arrives from the CN 110A for example, the UE 102 can maintain a connection the CN 110B, while the UE 102 starts activating a new connection to the CN 110A.

FIG. 1B depicts an example distributed or disaggregated implementation of any one or more of the base stations 104, 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or a Paging controller such as PDCP controller 134, 144, RRC controller 136, 146 and/or Paging controller 138, 148. In some implementations, the CU 172 can include a radio link control (RLC) controller configured to manage or control one or more RLC operations or procedures. In other implementations, the CU 172 does not include a RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The processing hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. If the CU-CP and DU(s) belong to a gNB, the CU-CP 172A can be connected to one or more DU 174s through an F1-C interface and/or an F1-U interface. If the CU-CP and DU(s) belong to an ng-eNB, the CU-CP 172A can be connected to one or more DU 174s through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

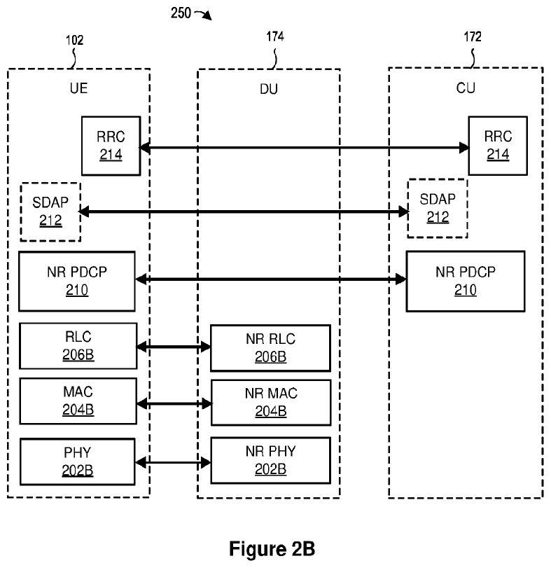

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets or Ethernet packets.

Thus, it is possible to functionally split the radio protocol stack, as shown by the radio protocol stack 250 in FIG. 2B. The CU 172 at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU 174. To support connection to a 5GC, NR PDCP 210 provides SRBs to RRC 214, and NR PDCP 210 provides DRBs to SDAP 212 and SRBs to RRC 214.

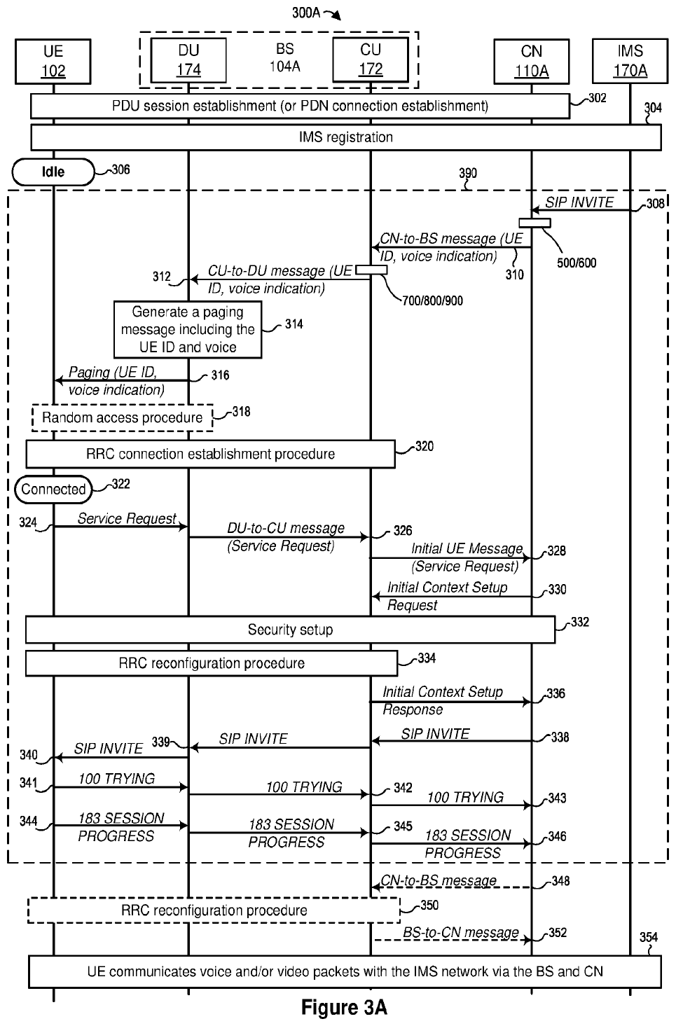

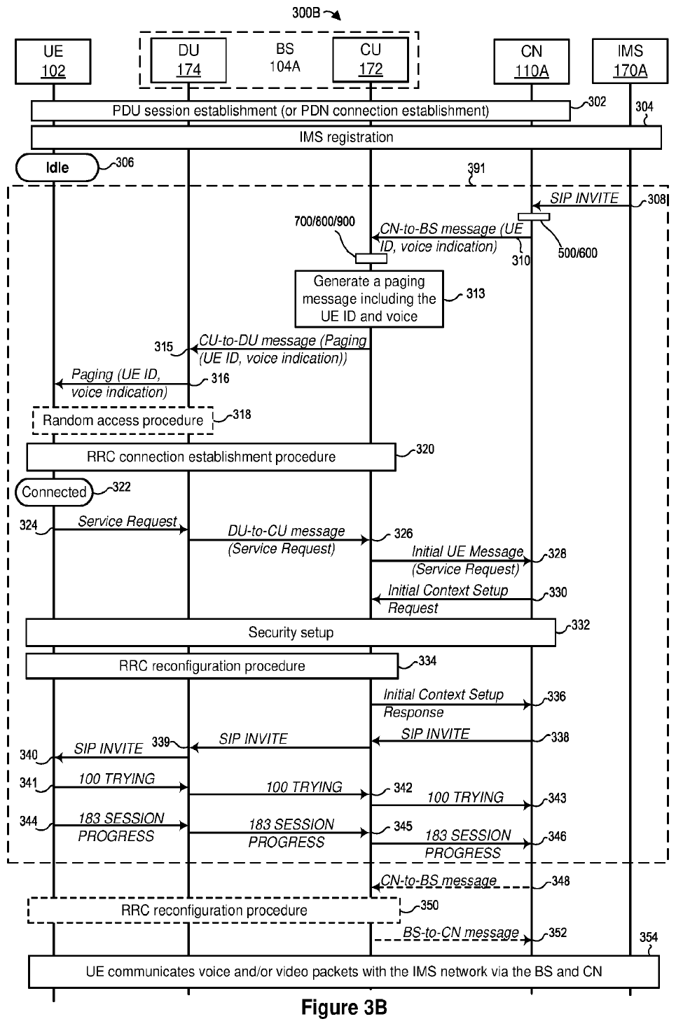

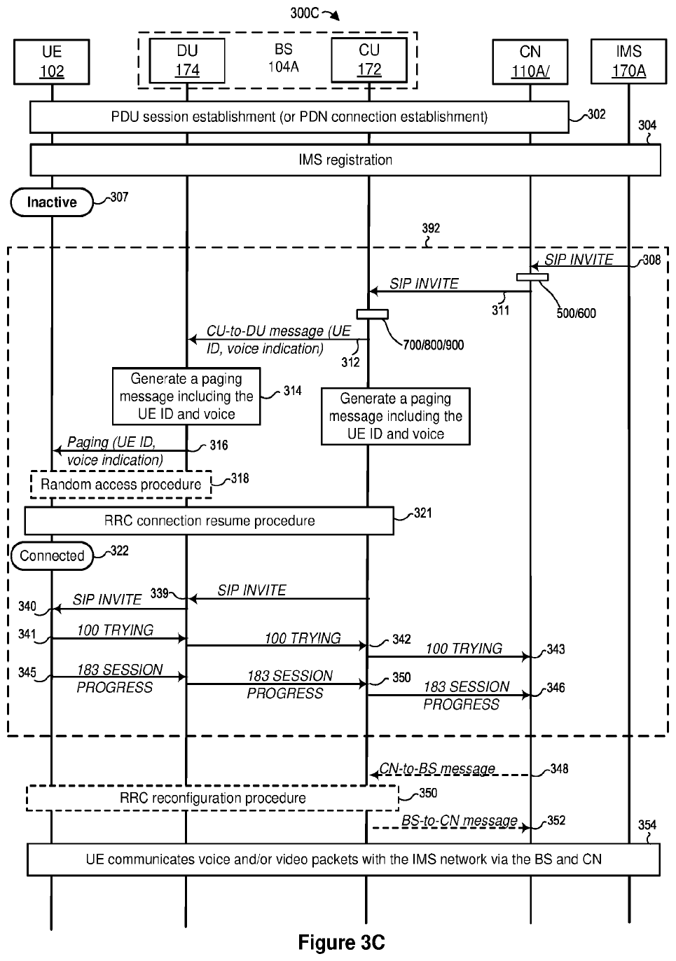

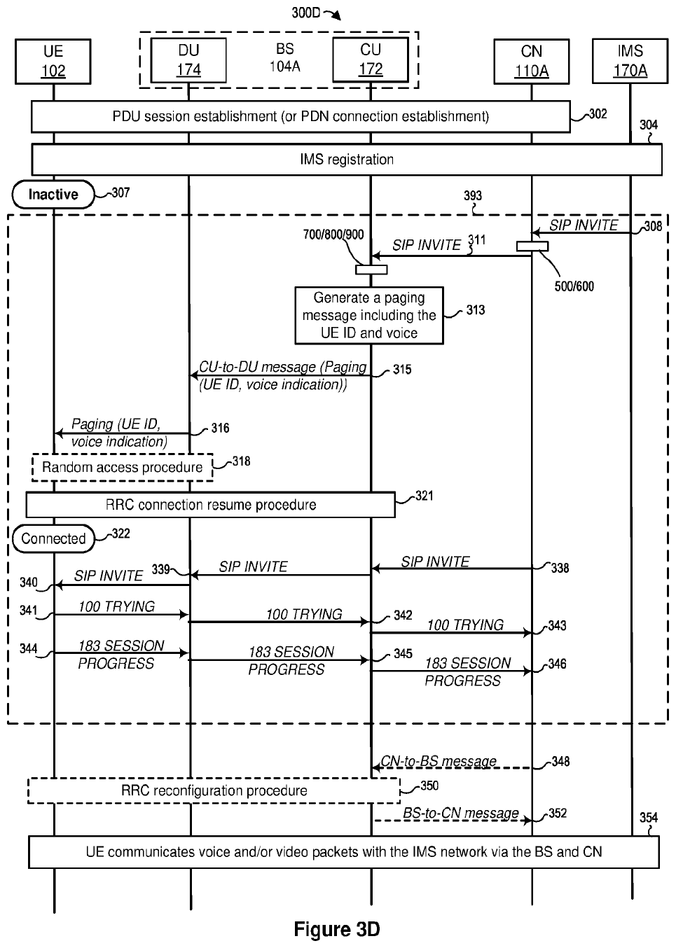

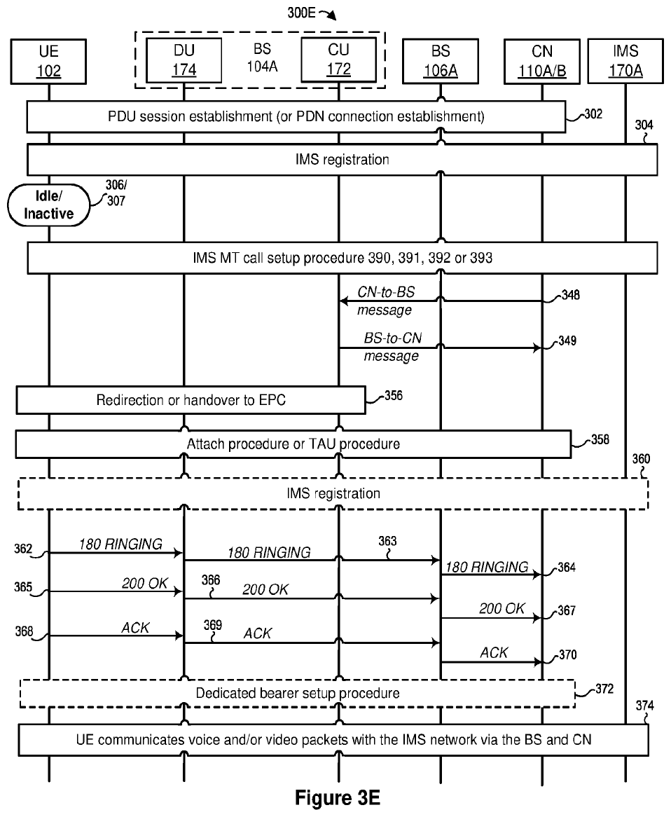

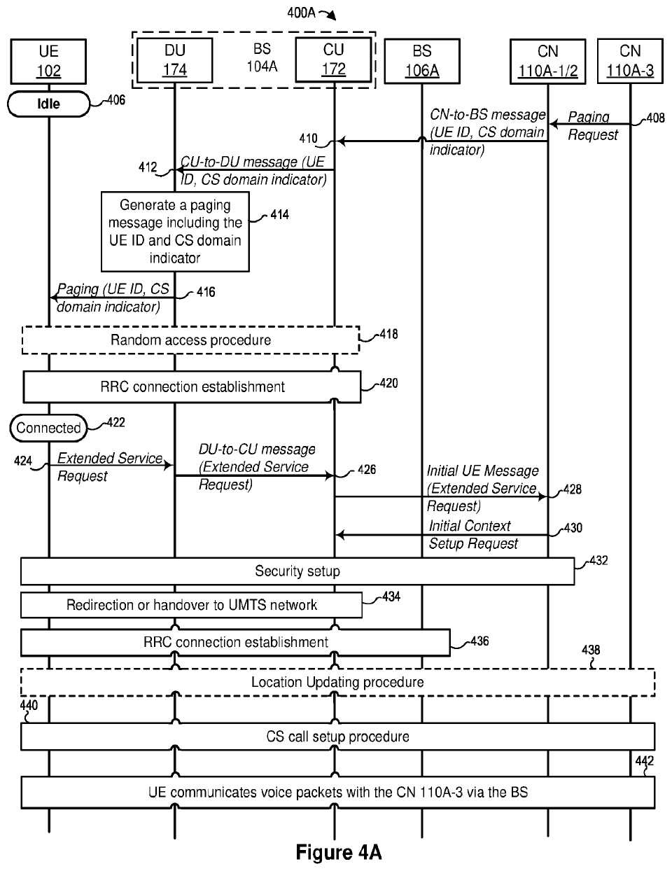

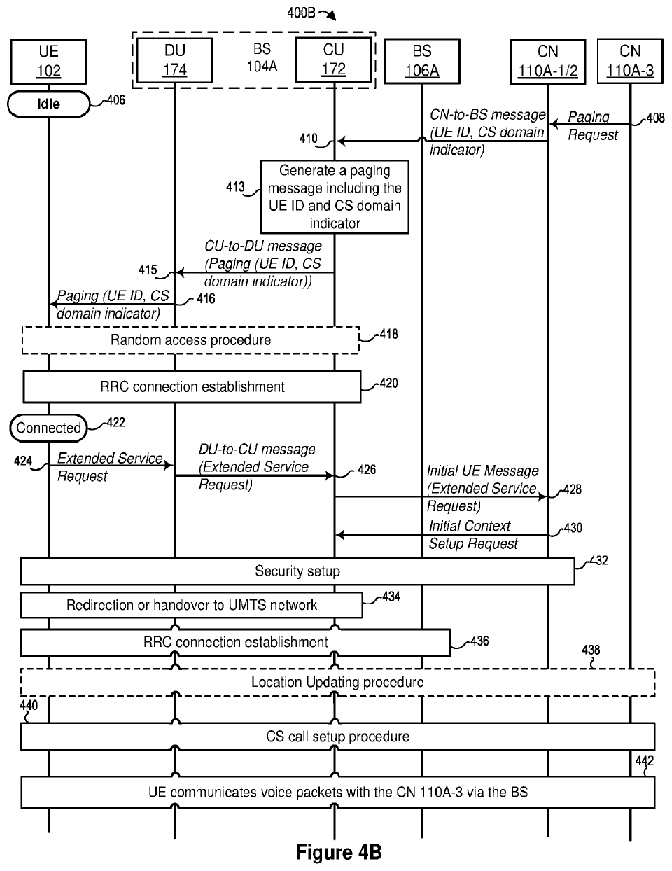

FIGS. 3A-4D are message sequences of example scenarios in which a CU transmits a paging enhancement configuration to a DU to enable the DU to page a UE using the paging enhancement configuration. Generally speaking, events in FIGS. 3A-3C and 4A-4D that are similar are labeled with similar reference numbers (e.g., event 394 in FIG. 3A is similar to event 394 in FIGS. 3B-3C and event 494 in FIGS. 4A-4D), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring to FIG. 3A, an example scenario 300 begins with a UE 102 establishing 302 a PDU session via CN 110A, via a distributed base station 104A. After establishing 302 the session (or a PDN connection), the IMS 102 performs 304 an IMS registration with an IMS 170A. The UE 102 then operates 306 in an idle state associated with a protocol for controlling radio resources (e.g., RRC_IDLE).

During an IMS mobile-terminated (MT) call setup procedure 390, the IMS 170A receives data for the UE 102 and transmits 308 an SIP INVITE message to the CN 110A. The CN 110A can implement a procedure 500 or 600, for example, to determine whether it should indicate a voice call for the UE 102 in a CN-to-BS message. In this scenario, the CN 110A includes a UE identity along with a voice indication in a CN-to-BS message and transmits 310 the message to the base station 104A.

The CU 172 of the base station 104A receives 310 the CN-to-BS message and implements a procedure 700, 800, or 900 for example to determine whether the CU should convey a voice indication to the DU. The CU 172 in this scenario includes a voice indication in a CU-to-DU message and transmits 312 the CU-to-DU message to the DU 174. In turn, the DU 174 generates 314 a paging message including the UE identity and a voice indication and initiates 316 paging of the UE 102.

After receiving 316 paging, the UE 102 performs 318 a random procedure with the DU 174, performs 320 an RRC connection establishment procedure with the DU 1743 and the CU 172, and begins to operate 322 in a connected state associated with a protocol for controlling radio resources (e.g., RRC_CONNECTED). The UE 102 then transmits 324 a service request message to the CN 110A via the DU 174 and CU 172 (326, 328). In response, the CN 110A transmits 330 a request to set up a UE context. The UE 102, the base station 104A, and the CN 110A then perform 332 a security setup procedure, followed by the UE 102A and the base 104A performing 334 an RRC reconfiguration procedure. When the RRC configuration procedure completes 334, the CU 172 transmits 336, to the CN 110A, a response to the request to set up a UE context.

The CN 110A then forwards 338 the SIP INVITE, received 308 from the IMS 170A, to the UE 102 via the base station 104A (339, 340). The UE 102 can transmit 341 a TRYING message to the CN 110A via the base station 104A (342, 343) and further transmit 344 a SESSION PROGRESS message via the base station 104A (345, 346) to the CN 110A. After the CN 110A optionally informs 348 the CU 172, via a CN-to-BS message, that the IMS MT call setup procedure 390 has been completed, the UE 102 and the base station 104A optionally perform 350 an RRC reconfiguration procedure, and the base station 104A transmits 352 an indication that the reconfiguration is complete to the CN 110A via a BS-to-CN message. The UE 102 then communicates (receives, transmits) 354 voice and/or video packets with the IMS 170A via the base station 104A and the CN 110A.

FIG. 3B illustrates a scenario 300B which is generally similar to the scenario 300A of FIG. 3A, but with the CU generating 313 the paging message. In particular, the CU generates 313 the paging message, includes the UE identity of the UE 102 and a voice indication, and forwards 315 the paging message to the DU 174 (rather than the DU generating 314 the paging message per scenario 300A).

Now referring to FIG. 3C, a scenario 300C similar to the scenario 300A, but here the UE 102 initially operates 307 in an inactive state. The CN 110A in this scenario transmits 311 a SIP INVITE message over user plane (UP) rather than over control plane (CP), unlike the scenario 300A. The CU 172 in this case processes the SIP INVITE to generate a CU-to-DU message with a voice indication and transmit 312 this message to the DU 174.

In some implementations, the UP interface protocol which the CU 172 and the CN 110A provides supports a flag that indicates that the CU should 172 should process the UP data packet. When the flag is not set, the CU simply forwards the UP data packet to the DU 174, without processing the content of the UP data packet. As discussed below with reference to procedures 700, 800, and 900, the CU 172 can effectively convert the SIP INVITE message, for voice or another IMS service, to a voice indication or another IMS indication.

Further, unlike the scenario 300A, the UE 102 begins to operate in the connected state after performing an RRC connection resume procedure rather performing 320 an RRC connection establishment procedure, because the UE 102 transitions to the connected state from the inactive state rather than from the idle state.

Referring to FIG. 3D, a scenario 300D is similar the scenario 300B FIG. 3B, but here the UE initially operates 307 in the inactive state.

Now referring to FIG. 3E, the scenario 300E is generally similar to that of FIGS. 3A-3D, but here the UE 102 initiates a redirection to a less advanced core network. The base station 104A in this scenario does not support voice over the RAT of the base station 104A (e.g., NR), and base station 104A redirects or hands the UE 102 over to the base station 106A. Although the scenario 300E can involve EPS fallback, FIG. 3E does not depict another CN, to reduce clutter.

The UE 102 initially can operate 306, 307 in an idle or connected state. After the IMS MT call procedure 390, 391, 392, or 393, during which the base station 104 provide a voice indication to the UE 102 during paging, the CN 110A and the CU 172 can negotiate 348, 349 redirection of the UE 102. The UE 102 and the base station 104 then initiate 356 a redirection or handover to EPC procedure. Next, the UE 102 performs 358 an attach procedure or a TAU procedure with the base station 106A and the CN 110A, which in this instance can be an EPC such as the CN 110B-2. After performing an IMS registration procedure 360, the UE 102 can provide 362-370 updates related to the IMS call to the CN 110B-2, perform 372 a dedicated bearer setup procedure, and start exchanging 374 IMS packets with the IMS 170A via the base station 106A and the CN 110B-2.

FIG. 4A illustrates a scenario 400A which is generally similar to the scenario 300A, but here the CU 172 forwards a circuit-switched (CS) domain indicator to indicate a voice call. Events in this scenario similar to those discussed above are labeled with similar reference numbers (e.g., with event 406 of FIG. 4A corresponding to event 306 of FIG. 3A, with event 418 of FIG. 4A corresponding to event 318 of FIG. 3A), and the examples and potential implementations for FIGS. 3A-E can apply to FIG. 4A. The differences between the scenarios of FIG. 4A and FIG. 3A are discussed below.

The CN 110A-1 or 110A-2, both of which are less advanced less than the CN-110A-3, transmits 410 a CN-to-BS message with a UE identity and a CS domain indicator to the CU 172, which then forwards 412 the UE identity and the CS domain indicator to the DU 174. When the DU 174 generates 414 a paging message for the UE 102, the DU 174 includes the CS domain indicator in the paging message, and pages 416 the UE 102 with the paging message. The UE 102 later transmits 424 an extended service request message to the CN 110A via the DU 174 and CU 172 (426, 428).

Next, a scenario 400B is generally similar the scenario 400A, but here the CU 172 formats 413 the paging message with the CS domain indicator, similar to the CU 174 generating 313 a paging message with a voice indicator in the scenario 300B discussed above.

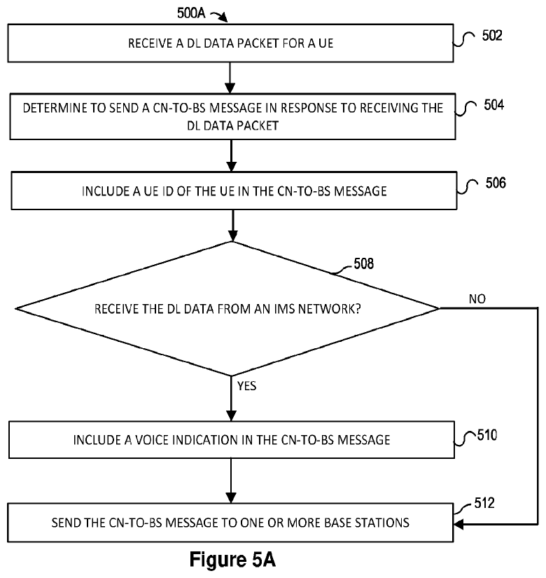

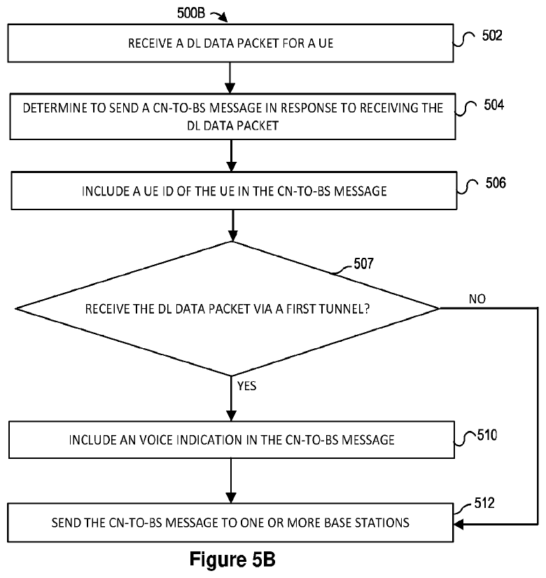

FIG. 5A illustrates a flow diagram of an example method 500A for generating a CN-to-BS message related to a UE and determining whether to include a voice indication, in view of whether downlink data for the UE is received from an IMS network, which can be implemented in a CN 110A for example.

At block 502, the CN receives a DL data packet addressed to a UE (e.g., the UE 102). At block 504, determines to generate a CN-to-BS message in response to receiving the DL data packet. The CN-to-BS message can include an NGAP paging message. At block 506, the CN includes the UE identity in the CN-to-BS message. Then, at block 508, the CN determines whether the DL data arrived from an IMS network (e.g., the IMS 170A). The flow proceeds to block 510 (yes) or to block 512 (no). At block 510, the CN includes a voice indication in the CN-to-BS message. At block 512, the CN sends the CN-to-BS to one or more base stations in the paging area of the UE.

In some implementations, the CN at block 508 (or prior to block 508, or after block 508) also checks whether the UE supports a voice indication in a paging message (e.g., a RRC Paging message). Thus, if the DL data packet arrived from an IMS network and the UE supports the voice indication in the paging message, the CN includes the voice indication in the CN-to-BS message. Otherwise, the CN refrains from including the voice indication in the CN-to-BS message.

In some implementations, the CN at block 512 can include another indication (e.g., “other” indication) in the CN-to-BS message to indicate other service(s) such as IMS services. In yet other implementations, the CN at block 512 does not include an indication in the CN-to-BS message to indicate service(s).

In some implementations, the CN determines that the UE supports the voice indication in the paging message in accordance with a ‘paging with a voice indication’ capability of the UE. The CN can obtain the paging with a voice indication capability from the UE via the RAN (not shown). For example, a base station of the RAN can send a UE Capability Enquiry message to the UE to obtain UE capabilities of the UE, and the UE in response can send to the base station a UE Capability Information message including multiple UE capabilities and the paging with a voice indication capability. In one implementation, the UE includes the UE capabilities and the paging with a voice indication capability in a UE-NR-Capability IE and includes the UE-NR-Capability IE in the UE Capability Information message. In another implementation, the UE includes the UE capabilities and the paging with a voice indication capability in a UE-EUTRA-Capability IE, and includes the UE-EUTRA-Capability IE in the UE Capability Information message.

The base station can send to the CN a BS-to-CN message including the UE capabilities and the paging with a voice indication capability. For example, the BS-to-CN message can be a NGAP message or a S1AP message. In another example, the BS-to-CN message can be a UE Radio Capability Info Indication message.

In another example, the UE sends to the CN a UL NAS message including or indicating the paging with a voice indication capability via the RAN. For example, the UL NAS message can be a Registration Request message, an Attach Request message, a Tracking Area Update Request message, a Registration Complete message, an Attach Complete message, or a Tracking Area Update Complete message.

FIG. 5B is a flow diagram of another example method 500B for generating a CN-to-BS message for a UE, in view of whether downlink data for the UE is received over a particular tunnel, which can be implemented in a CN of FIG. 1A. The differences between the methods 500A and 500B are considered next.

At block 507, the CN determines whether the DL data packet arrived via a certain (first) tunnel. For example, the CN can have two tunnels configured, the first tunnel and a second tunnel, with one or more data networks such as IMS network, the Internet, etc. In some implementations, the CN receives a tunneling packet including the DL data packet and a first tunnel endpoint ID (TEID) identifying the first tunnel. If the CN receives the DL data packet over the second tunnel, the CN refrains from including a voice indication in the CN-to-BS message. In this case, the tunneling packet includes the DL data packet and a second TEID identifying the second tunnel.

Similar to the method 500A, the CN at block 507 (or elsewhere in the flow of the method 500B) can also check whether the UE supports a voice indication in a paging message (e.g., a RRC Paging message). If the DL data packet arrived over the first tunnel and the UE supports the voice indication in the paging message, the CN includes 510 the voice indication in the CN-to-BS message. Otherwise, the CN refrains from including the voice indication in the CN-to-BS message.

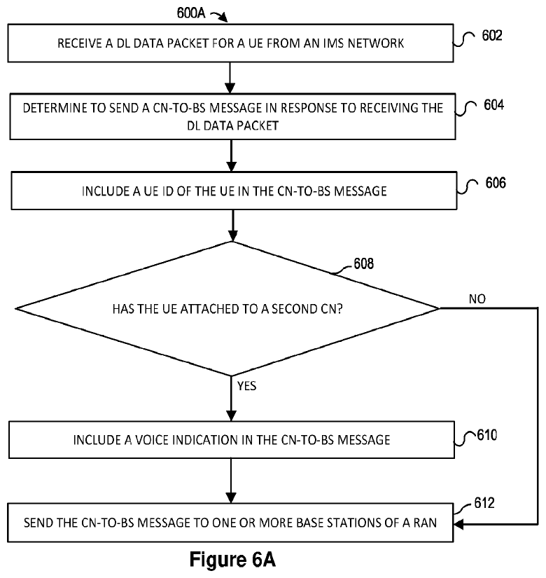

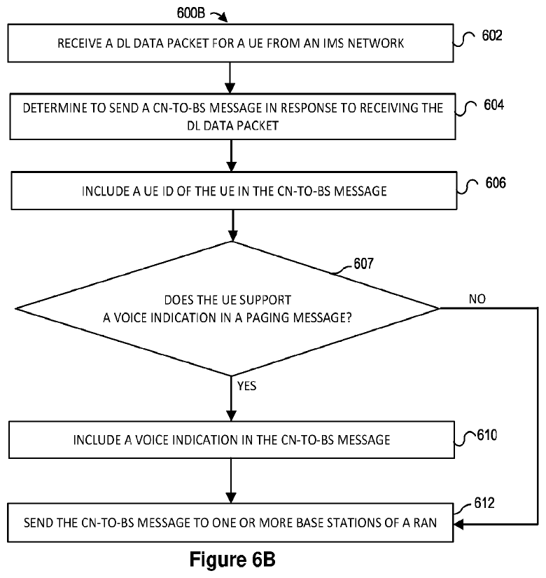

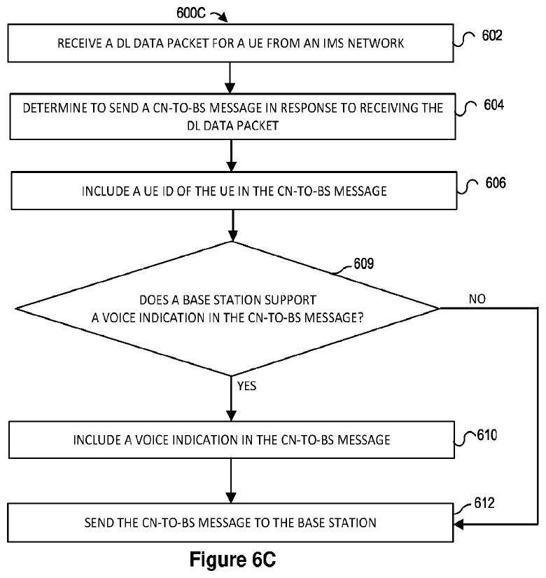

FIG. 6A is a flow diagram of an example method for generating a CN-to-BS message for a UE, in view of whether the UE is attached to another CN, which can be implemented in a CN of FIG. 1A. Blocks in FIGS. 5A-B and 6A-C that are similar to are labeled with similar reference numbers (e.g., block 502 in FIG. 5A is similar to block 602 in FIG. 6A), with differences discussed below where appropriate.

At block 608, the CN determines whether the UE has attached to (registered with) another CN and then proceeds either to block 610 (yes) to block 612 (no). If the UE has attached to only one (first) CN, the first CN refrains from including a voice indication in the CN-to-BS message (by proceeding from block 608 directly to block 612). Otherwise, the CN determines that the UE is a multi-SIM UE. In some implementations, the CN at block 612 can include another indication (e.g., “other” indication) in the CN-to-BS message to indicate other service(s) such as IMS. In other implementations, the CN at block 612 does not include an indication in the CN-to-BS message to indicate service(s).

In some implementations, the CN can check whether the DL data (e.g., SIP INVITE message) is for a voice or video service. If the UE has attached to a second CN and the DL data is for a voice or video service, the CN includes 610 the voice indication in the CN-to-BS message. Otherwise, the CN refrains from including the voice indication in the CN-to-BS message.

In some implementations, the first CN determines that the UE has attached to a second CN when the first CN receives, from the UE via a base station, a NAS message including assistance information indicating (explicitly or implicitly) that the UE has attached to the second CN. For example, the assistance information can report paging collision between the first CN and the second CN. In another example, the assistance information includes one or more parameters (e.g., a UE ID offset) for the first CN to determine a new paging DRX configuration which resolves paging collision between the first CN and the second CNs for the UE. In yet another example, the assistance information includes one or more parameters (e.g., a UE ID offset) for the first CN to determine one or more configuration parameters for the UE to perform network switching to the second CN while leaving a connected state with the first CN. If the first CN does not receive the NAS message or the assistance information from the UE, the first CN can determine that the UE has not attached to a second CN. If the first CN receives from the UE a second NAS message indicating the UE has not attached to another CN (e.g., the second CN), the first CN can determine that the UE does not attach to another CN (e.g., the second CN) in accordance with the second NAS message.

In other implementations, the first CN determines that the UE has attached to a second CN if the first CN receives, from a base station, a BS-to-CN message including assistance information indicating (explicitly or implicitly) that the UE has attached to the second CN. In this case, the base station can generate the assistance information after receiving an RRC message from the UE. For example, the UE can send the RRC message to report paging collision between the first CN and the second CN, and the assistance information reports paging collision between the first CN and the second CN. In another example, the UE sends to the base station the RRC message including one or more parameters (e.g., a UE ID offset) to assist the base station to page the UE. Thus, the assistance information includes the one or more parameters (e.g., a UE ID offset) which the first CN can use to determine a new paging DRX configuration which resolves paging collision between the first CN and the second CNs for the UE. In yet another example, the RRC message includes one or more parameters for network switching to the second CN while leaving a connected state with the first CN. If the first CN does not receive the BS-to-CN message or the assistance information from the base station, the first CN can determine that the UE does not attach to another CN (e.g., the second CN). If the first CN receives from the base station a second BS-to-CN message indicating that the UE has not attached to another CN (e.g., the second CN), the first CN can determine that the UE has not attached to another CN (e.g., the second CN) in accordance with the second BS-to-CN message.

FIG. 6B illustrates an example method 600B generally similar to the method 600A. However, a CN according to the method 600B determines, at block 607, whether the UE supports a voice indication in a paging message and then proceeds either to block 610 (yes) to block 612 (no). The support of voice indication can be a UE capability, which the CN can obtain as discussed above with reference to FIG. 6A. Further, the CN in some cases implements both the method 600A and the method 600B.

FIG. 6C illustrates another example method 600C generally similar to the method 600A. However, here the CN determines, at block 609, whether the base station supports a voice indication in a CN-to-BS message. If the base station does not support a voice indication in a CN-to-BS message, the CN refrains from including a voice indication in the CN-to-BS message, by proceeding from block 609 directly to block 612. The base station otherwise can consider a message including a voice indication to be corrupted.

In some implementations, the CN determines whether the DL data (e.g., SIP INVITE message) is for a voice or video service. If the base station supports a voice indication in a paging message, and the DL data is for a voice or video service, the CN includes 610 the voice indication in the CN-to-BS message. Otherwise, the CN refrains from including the voice indication in the CN-to-BS message.

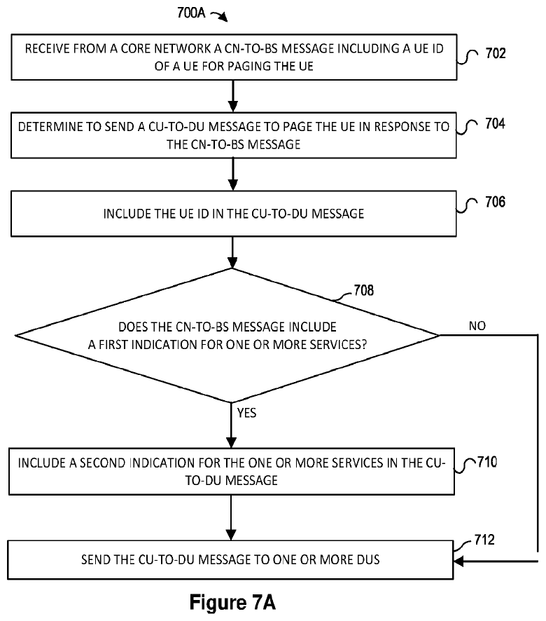

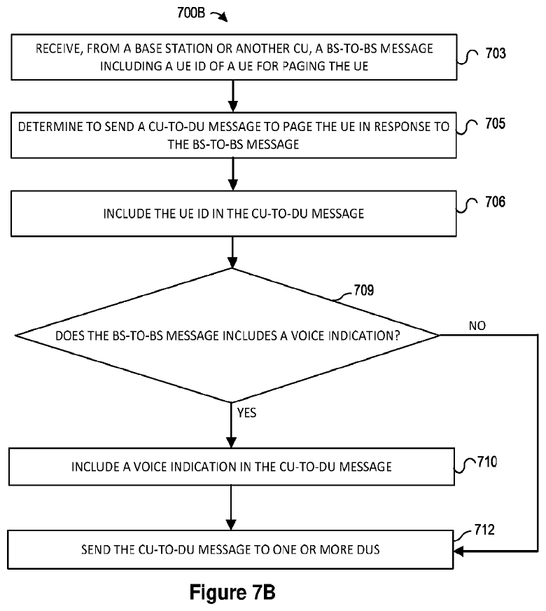

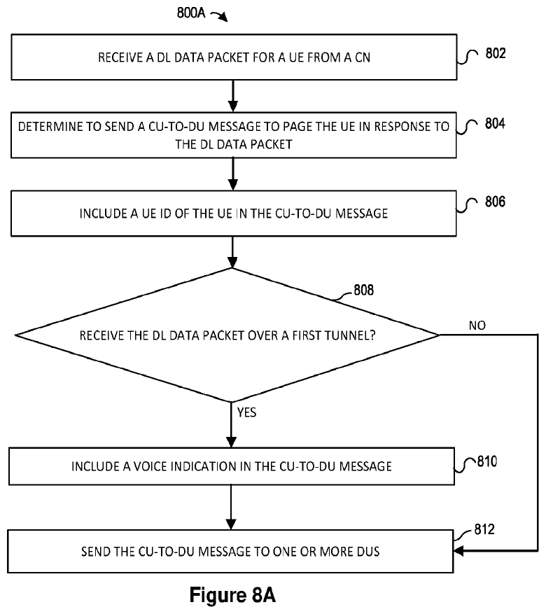

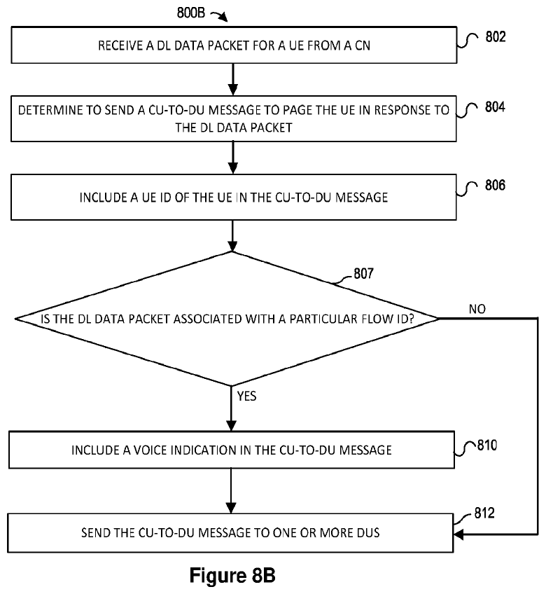

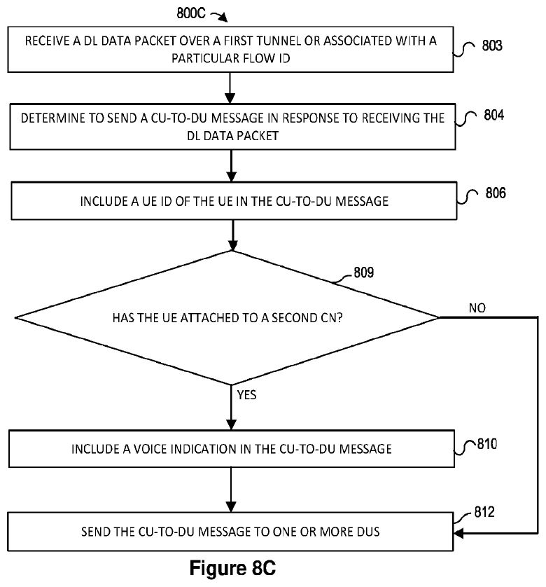

Next, several method that can be implemented in a CU, such as the CU 172, are discussed with reference to FIGS. 7A-8C.

Referring first to FIG. 7A, a CU can implement an example method 700A to generate a CU-to-DU message addressed to a UE. At block 702, the CU receives a CN-to-BS message including a UE identity of the UE, for paging the UE. For example, the CN-to-BS message can be a NGAP Paging message or a S1AP Paging message. At block 704, the CU determines to send a CU-to-DU message to page the UE and, at block 706, includes the UE identity in the CU-to-DU message.

At block 708, the CU determines whether the CN-to-BS message includes a certain (first) indication for one or more services. If the CN-to-BS message does not include an indication for service(s), the CU refrains from including an indication for the service(s) in the CU-to-DU message, by proceeding directly to block 712. Otherwise, the flow proceeds to block 710 (yes), where the CU includes a certain (second) indication for the one or more services, in the CU-to-DU message before sending 712 the CU-to-DU message to one or more DUs.

In some implementations, the first indication can be a voice indication, which can be an information element (IE) of the CN-to-BS message, and the second indication) is a voice indication as an IE of the CU-to-DU message. In other implementations, the first indication is the “other” indication formatted as an IE of the CN-to-BS message, and the second indication is the “other” indication formatted an IE of the CU-to-DU message. In some implementations, the CU-to-DU message is F1AP paging message or W1AP paging message, to direct the DU to page the UE. For example, the CU-to-DU paging message can be a paging message defined in 3GPP specifications 38.473 or 37.473.

If CN-to-BS is a control plane (CP) message such as an NGAP message, and the UE is idle (or can be assumed to be idle), the first indication can be the voice indication per FIG. 3A. In another implementation, if the CN-to-BS message is a general message from the CN, such as a data plane message, and the US is inactive (or can be assumed to be inactive), the first indication could be a SIP INVITE.

Referring to FIG. 7B, an example method 700B for generating a CU-to-DU message for a UE begins at block 703, where the CU receives a BS-to-BS message from another base station, which can be distributed or non-distributed. The BS-to-BS message is for paging the UE and includes the identity of the UE. The BS-to-BS message can be an Xn Paging message or an X2 Paging message, for example.

At block 705, the CU determines that it should send a CU-to-DU message to page the UE, in response to the BS-to-BS message. At block 705, the CU includes the UE identity in the CU-to-DU message.

Next, at block 709, the CU determines whether the BS-to-BS message includes a voice indication and proceeds to block 710 (yes) or block 712 (no). In particular, if the BS-to-BS message does not include an indication for service(s) such as IMS voice, the CU refrains from including an indication for the service(s) in the CU-to-DU message.

In some implementations, the indication in the BS-to-BS message is a voice indication formatted as an IE of the BS-to-BS message, and the second indication is a voice indication formatted as an IE of the CU-to-DU message. In other implementations, the indication in the BS-to-BS message is the “other” indication formatted as an IE of the BS-to-BS message, and the indication in the CU-to-DU message is the “other” indication formatted as an IE of the CU-to-DU message.

FIG. 8A is a flow diagram of an example method 800A for generating a CU-to-DU message for a UE, in view of whether a data packet for the UE arrives over a particular tunnel, which can be implemented in a CU. The CU generally can use the tunnel ID to distinguish between tunnels. According to the method 800A, the CU need not implement the SIP stack to determine the content of a SIP message.

To start the flow diagram, the CU receives 802 a DL data packet for a UE from a CN. The CU then determines 802 to send a CU-to-DU message to page the UE and includes 806 the UE identity in the CU-to-DU message. Next, the CU determines 808 whether the DL data packet arrived via a certain (first) tunnel. For example, the CU can have two tunnels configured, the first tunnel and a second tunnel, with the CN. In some implementations, the CU can receive from the CN a tunneling packet including the DL data packet and a first tunnel endpoint ID (TEID) identifying the first tunnel which supports IMS voice data transfer. If the CU receives the DL data packet over the second tunnel, the CU refrains from including a voice indication in the CU-to-DU message. In this case, the tunneling packet includes the DL data packet, and a second TEID identifying the second tunnel. In some implementations, the CN includes 812 another indication (e.g., “other” indication) in the CU-to-DU message to indicate other service(s) such as IMS voice. In other implementations, the CU at block 812 does not include an indication in the CU-to-DU message to indicate service(s).

In some implementations, the CU can determine whether the UE supports a voice indication in a paging message (e.g., an RRC Paging message). If the DL data packet arrives over the first tunnel, and the UE supports the voice indication in the paging message, the CU includes 810 the voice indication in the CU-to-DU message. Otherwise, the CU refrains from including the voice indication in the CU-to-DU message.

In some implementations, the CU determines that the UE supports the voice indication in the paging message in accordance with a ‘paging with a voice indication’ capability of the UE. The CU can obtain the paging with a voice indication capability from the UE, the CN, or another base station using procedure similar to that described earlier with reference to FIG. 5 and a BS sending a UE Capability Enquiry message to the UE 102.

In another example, the CU receives, from the CN a CN-to-BS message including multiple UE capabilities and the paging with a voice indication capability. For example, the CN-to-BS message can be a NGAP message or a S1AP message. In another example, the CN-to-BS message is an Initial Context Setup Request message, a Connection Establishment Indication message, a UE Information Transfer message, a Downlink NAS Transport message, or a UE Radio Capability ID Mapping Response message.

FIG. 8B illustrates a method 800B generally similar to the method of FIG. 8A, and the differences are briefly discussed below. At block 807, the CU determines whether a data packet for the UE is associated with a particular flow. For example, the particular flow ID can be a first flow with a certain flow ID. The CU can receive a protocol packet including the DL data packet and the first flow ID from the CN. If the DL data packet is associated with another (second) flow ID, the CU refrains from including a voice indication in the CU-to-DU message by proceeding from block 807 directly to block 812. In this case, the protocol packet can include the DL data packet and the second flow ID. In some implementations, the flow ID(s) can be Quality of Service (QOS) flow ID(s).

In an example implementation, each data packet the CU receives includes a QoS flow ID (“QF”), or more generally a “flow ID,” in a header of the data packet and in the container packet. When the CU receives the container packet, the CU can identify the QoS flow. Each QoS flow is associated with a 5QI value, and the CU can determine from the 5QI characteristics whether the flow ID is affiliated with IMS or IMS-voice.

In some implementations, the CU further checks whether the UE supports a voice indication in a paging message (e.g., a RRC Paging message). If the DL data packet is associated with the particular flow ID, and the UE supports the voice indication in the paging message, the CU includes 810 the voice indication in the CU-to-DU message. Otherwise, the CU refrains from including the voice indication in the CU-to-DU message.

FIG. 8C illustrates an example method 800C also similar to the method 800A, but here the CU determines whether to include a voice indication in a CU-to-DU message in view of whether the UE is attached to another CN. In particular, at block 809, the CU determines whether to UE has attached to another (second) CN and, if so, the flow proceeds to block 810. Otherwise, if the UE has attached to only the first CN, the CU refrains from including a voice indication in the CN-to-BS message by proceeding directly to sending 812 a CU-to-DU message to one or more DUs.

In some implementations, the CU determines that the UE has attached to a second CN if the CU receives, from the UE, an RRC message including assistance information which indicates that the UE attached to the second CN. For example, the assistance information reports paging collision between the first CN and the second CN. In another example, the assistance information includes one or more parameters (e.g., a UE ID offset) for the first CN to determine a new paging DRX configuration which resolves, for the UE, paging collision between the first CN and the second CN. In yet another example, the assistance information includes one or more parameters (e.g., a UE ID offset) for the CU to determine one or more configuration parameters for the UE to perform network switching to the second CN while retaining a connected state with the CU. If the CU does not receive the RRC message or the assistance information from the UE, the CU can determine that the UE does not attach to another CN (e.g. the second CN). If the CU receives from the UE a second RRC message indicating the UE does not attach to another CN (e.g., the second CN), the CU can determine that the UE does not attach to another CN (e.g., the second CN) in accordance with the second RRC message.

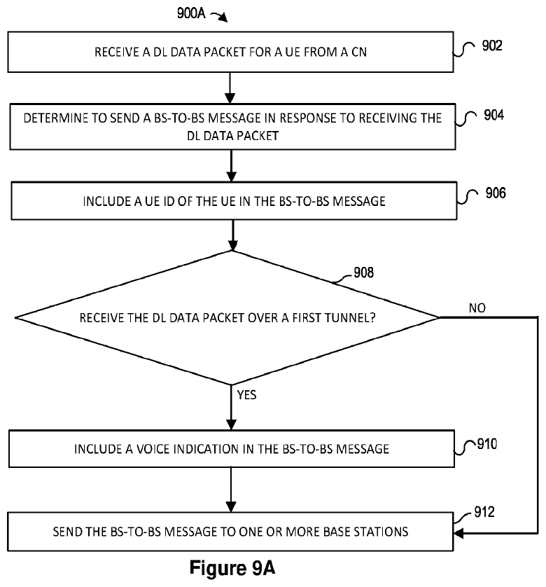

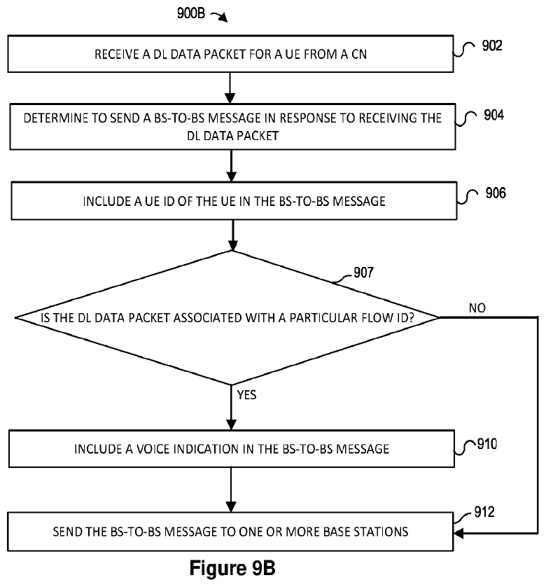

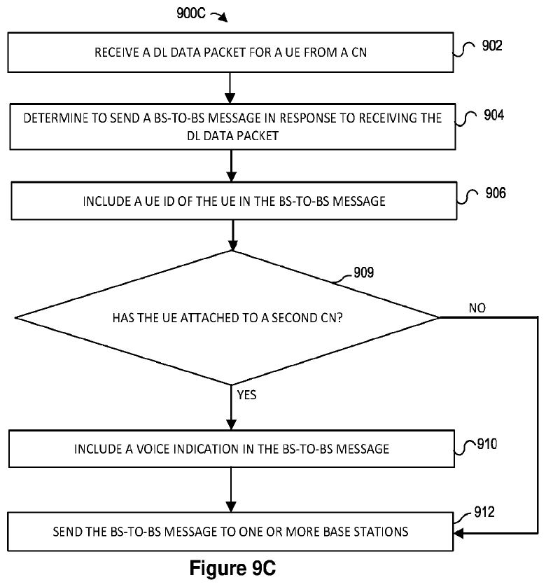

FIG. 9A illustrates an example method 900A in a CU for generating a BS-to-BS message in the RAN paging area, addressed to a UE. The method 900A can be understood as the “last-serving base station.” Blocks 902-906 are similar to blocks 802-806, respectively. At block 908, the CU determines whether the DL data packet arrived over a certain (first) tunnel. If the DL data packet arrived over the first tunnel, the CU includes 910 a voice indication in the BS-to-BS message. Otherwise, the CU refrains from including the voice indication in the BS-to-BS message by proceeding from block 908 directly to sending 912 the BS-to-BS message to one or more base stations.

Referring to FIG. 9B, an example method 900B is similar to the method 800B and 900A, but here the CU at block 907 determines whether a data packet for the UE is associated with a particular flow and proceeds to block 910 (yes) or directly to block 912 (no).

Regarding FIG. 9C, an example method 900C is similar to the method 600A, 800C and 900A, but here the CU at block 909 determines whether the UE has attached to another CN and proceeds to block 910 (yes) or directly to block 912 (no).

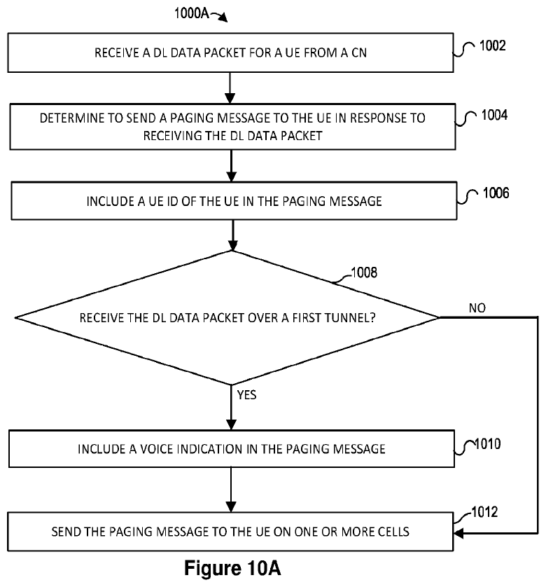

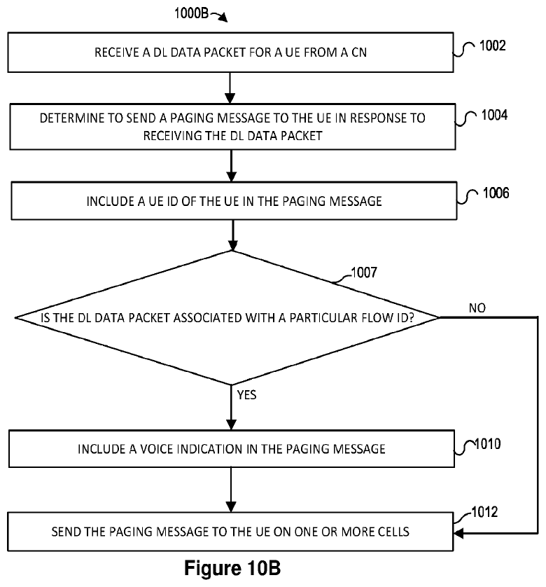

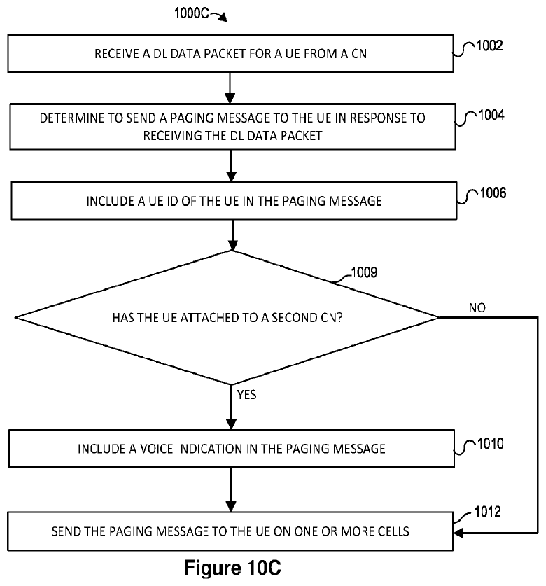

Next, FIGS. 10A-C illustrate methods 1000A-C that can be implemented in a base station, which need not necessarily be distributed. At block 1002, the base station receives a DL data packet for a UE from a CN. At block 1004, the base station determines to send a paging message to page the UE and includes 1006 the UE identity in the paging message. Next, the base station determines 1008 whether the DL data packet arrived via a certain (first) tunnel, similar to the discussion of block 808 of FIG. 8A. The base station then proceeds (yes) to block 1010 and includes a voice indication in the paging message or proceeds (no) to block 1012 and sends a paging message to the UE on or more cells.

Referring to FIG. 10B, the method 1000B is similar to the method 500B, 800B, and 1000A, but here the base station determines 1007 whether a data packet for the UE is associated with a particular flow and proceeds to block 1010 if yes, and to block 1012 if no.

FIG. 10C illustrates an example method 1000C for generating a paging message in view of whether the UE is attached to another CN. The method 1000C is similar to the method 600A, 800C, 900C, and 1000A, but here the base station determines 1009 whether the UE has attached to another CN, using similar techniques discussed with reference to FIG. 6A, and proceeds to block 1010 is yes, and to block 1012 if no.

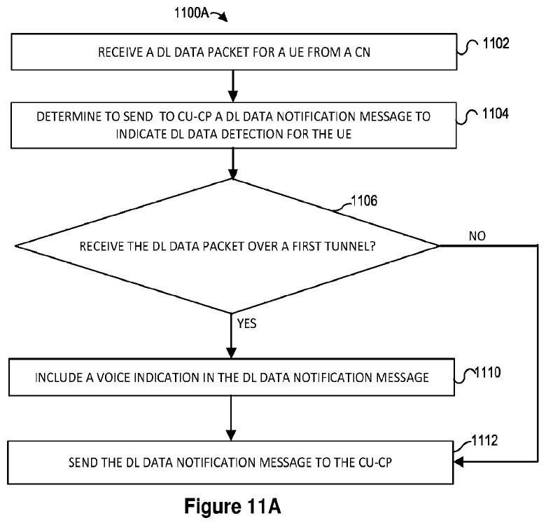

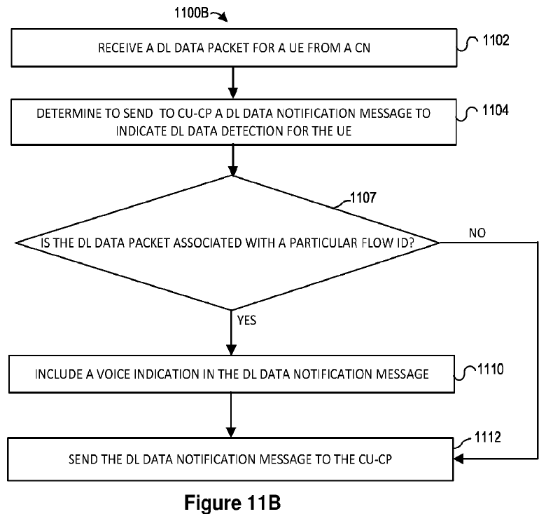

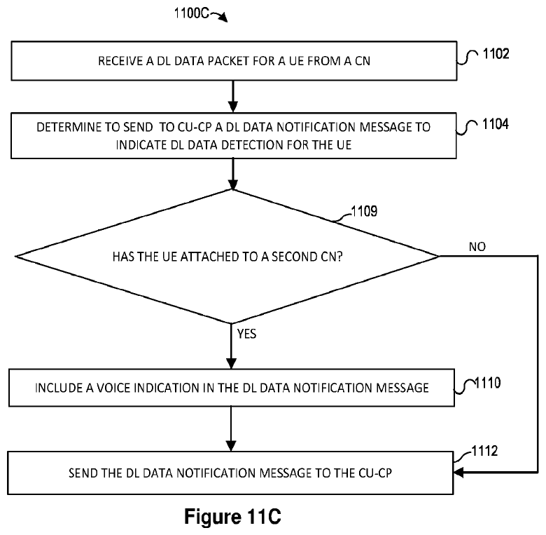

FIGS. 11A-C are flow diagrams of example methods 1100A-C for generating a message for a CU-CP, which can be implemented in the CU-UP of a CU. As the flow diagram begins, the CU-UP receives 1102 a DL data packet for a UE from the CN. Next, the CU-UP determines 1104 to send a DL data notification message to the CU-CP. At block 1106 (FIG. 11A), the CU-UP determines whether the DL data packet was received at a particular tunnel; at block 1107 (FIG. 11B), the CU-UP determines whether the DL data packet is associated with a particular flow ID; and at block 1109, the CU-UP determines whether the UE has attached to another CN (FIG. 11C). If the decision at block 1106, 1107, or 1109 is yes, the CU-UP includes 1110 a voice indication in the DL data notification message for the CU-CP. Otherwise, the flow proceeds directly to block 1112, where the CU-UP sends the DL data notification message to the CU-CP.

FIG. 12 is a flow diagram of an example method 1200 for generating a CU-to-DU message for a UE, which can be implemented in a CU-CP of the CU. At block 1202, the CU-CP receives a DL data notification message and, at block 1204, the CU-CP determines to generate a response to the CU-UP. At block 1206, the CU-CP includes the UE identity in the CU-to-DU message. At block 1208, the CU-CP determines whether the DL data notification message includes a voice indication and, if yes, include a voice indication in the CU-to-DU message (block 1210). If the CU-CP determines 1208 that the DL data notification message does not include a voice indication, the CU-CP sends 1212 a CU-to-DU message to one or more DUs without including a voice indication.

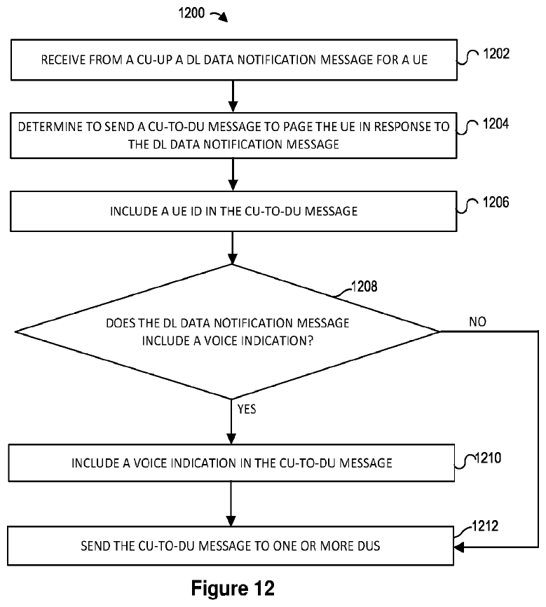

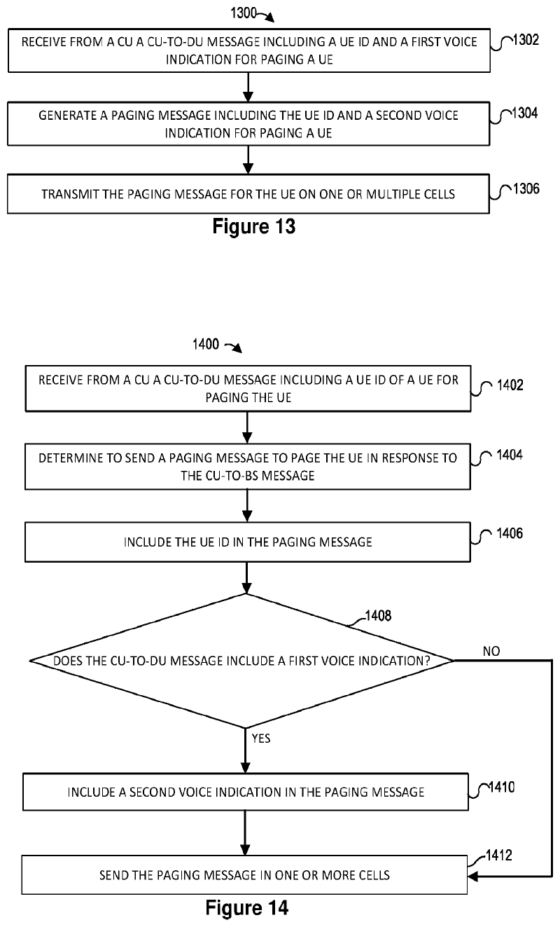

FIG. 13 illustrates an example method 1300 for changing the format of a voice indication, which can be implemented in a DU of a distributed base station. At block 1302, the DU receives, from a CU, a CU-to-DU message including a UE identity and a first voice indication for a UE. Next, the UE generates 1304 a paging message including the UE identity and a second voice indication for paging the UE. Generally speaking, the first and second voice indications can be different IEs (NGAP, F1AP) of their corresponding interface messages. At block 1306, the DU transmits the paging message for the UE on one or multiple cells.

Next, FIG. 14 illustrates an example method 1400 for changing the format of a voice indication when generating a paging message, which can be implemented in a DU of a distributed base station. Initially, the DU receives 1402 a CU-to-DU message including a UE identity of a UE, for paging the UE. Next, the DU determines 1404 that it should send a paging message to the UE in response to the CU-to-BS message. Then, the DU includes 1406 the UE identity in the paging message.

At block 1408, the DU determines whether the CU-to-DU message includes a certain (first) voice indication and, if so, the DU includes 1410 a (second) voice indication in the paging message. The first and second voice indications can have the same format or different formats, depending on the implementation. If the CU-to-DU message does not include the first voice indication, the flow proceeds directly to the DU sending 1412 the paging message in one or more cells.

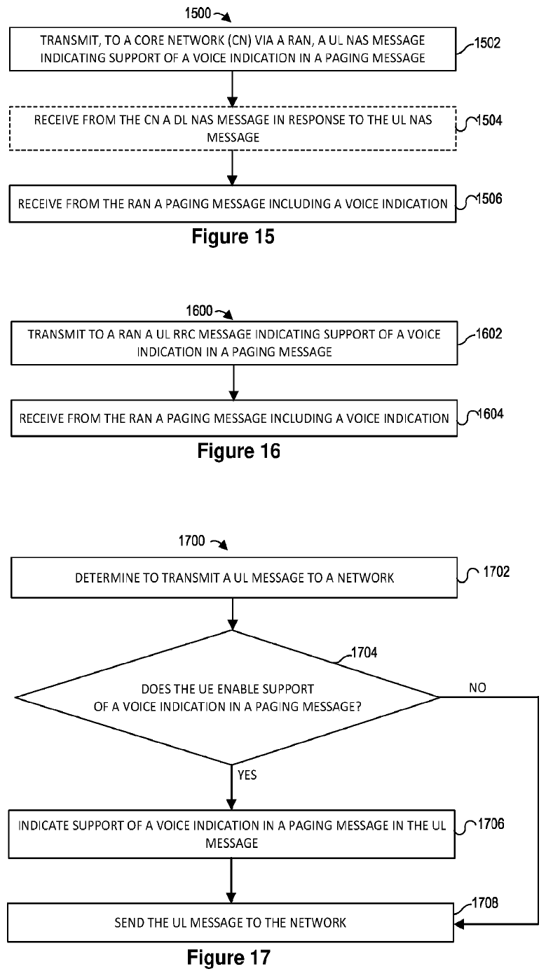

FIG. 15 is a flow diagram of an example method 1500 for receiving a paging message in accordance with a UE-specified capability, which can be implemented in a UE, such as the UE 102. The UE transmits 1502, to a core network (CN) via a RAN, a UL NAS message indicating support of a voice indication in a paging message. At optional block 1504, the UE receives, from the CN, a DL NAS message in response to the UL NAS message. At block 1506, the UE receives from the RAN a paging message including a voice indication.

FIG. 16 is a flow diagram of an example method 1600 for receiving a paging message in accordance with a UE-specified capability, which can be implemented in a UE. At block 1602, the UE transmits to a RAN a UL RRC message indicating support of a voice indication in a paging message. At block 1604, the UE receives from the RAN a paging message including a voice indication.

FIG. 17 is a flow diagram of an example method 1700 for indicating capability of a UE to the CN, with respect to voice indication, which can be implemented in UE. At block 1702, the UE determines to transmit a UL message to a network. At block 1704, the UE determines whether the UE has enabled or activated support a voice indication in a paging message. The flow proceeds (yes) to block 1706, where the UE indicates support of a voice indication in a paging message in the UL message, or directly to block 1708, where the UE sends the UL message to the network.

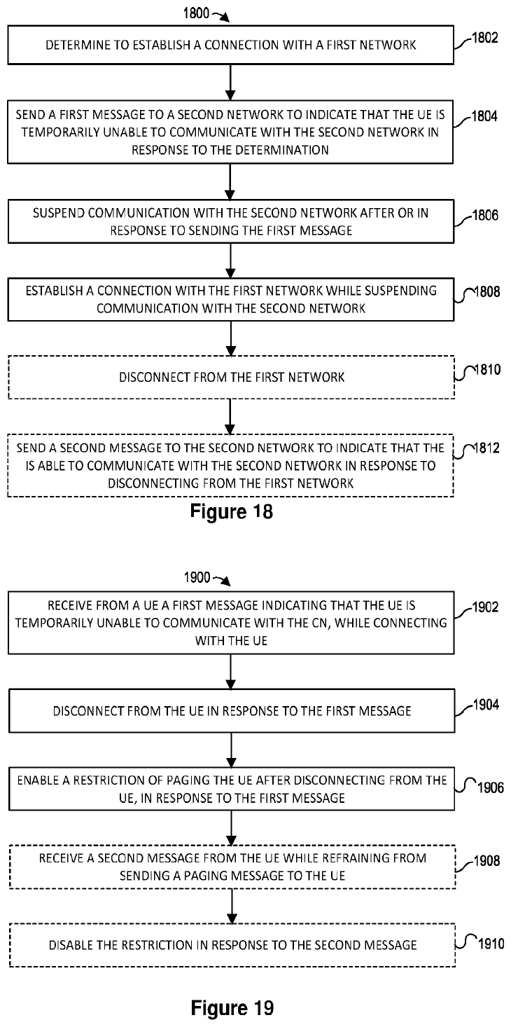

Next, FIG. 18 illustrates an example method 1800 in a UE for indicating, to one of the CNs with which the UE is registered, that the UE is temporarily unable to communicate with a second CN. At block 1802, the UE determines to establish a connection with a first network. At block 1804, the UE sends a first message to a second network to indicate that the UE is temporarily unable to communicate with the second network in response to the determination. At block 1806, the UE suspends communication with the second network after or in response to sending the first message. At block 1808, the UE establishes a connection with the first network while suspending communication with the second network. At optional block 1810, the UE disconnects from the first network and, at optional block 1812, the UE sends a second message to the second network to indicate that the is able to communicate with the second network in response to disconnecting from the first network.

FIG. 19 illustrates an example method 1900 for restricting paging of a UE, which can be implemented a CN. At block 1902, the CN receives, from a U, a first message indicating that the UE is temporarily unable to communicate with the CN, while connecting with the UE. At block 1904, the CN disconnects from the UE in response to the first message. At block 1906, the CN enables or activates a restriction of paging the UE after disconnecting from the UE, in response to the first message. At optional block 1908, the CN receives a second message from the UE while refraining from sending a paging message to the UE. At optional block 1910, the DU disables the restriction in response to the second message.

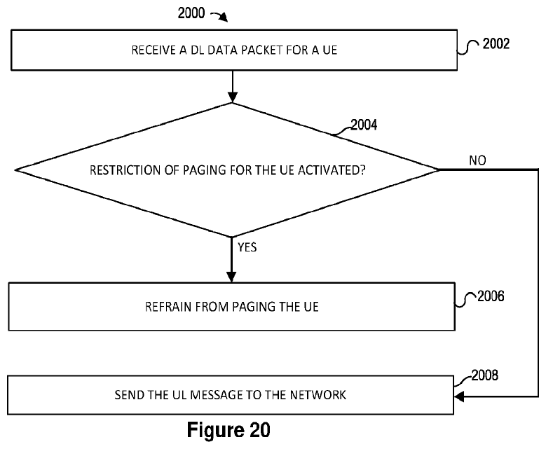

FIG. 20 is a flow diagram of an example method 2000 for restricting paging of a UE, which can be implemented in a CN. At block 2002, the CN receives a DL data packet for a UE. At block 2004, the CU determines whether it has activated a restriction of paging for the UE. If the restriction is activated, the flow proceeds to block 2006, where the CN refrains from paging the UE. Otherwise, if the CU determines that it has not activated a restriction of paging for the UE, the flow proceeds to block 2008, where the CN sends an UL message to the network.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “early data communication” can be replaced by “small data communication” and “early data transmission” can be replaced by “small data transmission”.

If a cell is operated in a Time Division Duplex (TDD) mode or on a TDD carrier frequency, a DL BWP and a UL BWP (i.e., associated with the DL BWP) of the cell can be the same BWP. If a cell is operated in a Frequency Division Duplex (FDD) mode or on a pair of FDD carrier frequencies (i.e., UL carrier frequency and DL carrier frequency), a DL BWP and a UL BWP (i.e., associated with the DL BWP) of cell are different BWPs. In this case, the DL BWP is a BWP of the DL carrier frequency and the UL BWP is a BWP of the UL carrier frequency. In some implementations, one of the UL BWPs of a cell can partially overlap the other or has no overlap with the other. In other implementations, one of the UL BWPs can be entirely within the other. In some implementations, one of the DL BWPs of a cell can partially overlap the other or has no overlap with the other. In other implementations, one of the DL BWPs can be entirely within the other.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of additional embodiments explicitly contemplated by the present disclosure.

Example 1. A method, implemented in a distributed unit (DU) of a distributed base station, for paging a UE, the method comprising: receiving, by processing hardware from a central unit (CU) of the distributed base station and when the UE is not operating in a connected state of a protocol associated with controlling radio resources, a CU-to-DU message related to the UE and indicating a voice call; and transmitting, by the processing hardware to the UE via a radio interface, a paging message including an indication of the voice call.

Example 2. The method of example 1, further comprising: generating, by the processing hardware, the paging message at the DU, based on the CU-to-DU message.

Example 3. The method of example 1, wherein the CU-to-DU message contains the paging message.

Example 4. The method of any of the preceding examples, wherein the CU-to-DU message includes a voice indication field.

Example 5. The method of example 4, wherein: the voice indication field is formatted according to a first protocol; and transmitting the indication of the voice call includes transmitting the voice indication field formatted according to a second protocol.

Example 6. The method of any of examples 1-3, wherein the CU-to-DU message includes a circuit-switched (CS) domain indicator field.

Example 7. The method of example 6, wherein transmitting the indication of the voice call includes transmitting the CS domain indicator field.

Example 8. The method if any of the preceding examples, further comprising: determining, in response to receiving the CU-to-DU message, that the UE is an idle state of the protocol.

Example 9. The method of any of examples 1-7, further comprising: determining, in response to receiving the CU-to-DU message, that the UE is an inactive state of the protocol.

Example 10.The method of any of the preceding examples, wherein the CU-to-DU message is one of: an F1AP paging message, or a W1AP paging message.

Example 11. A method for paging a UE, implemented in a central unit (CU) of a distributed base station operating in a radio access network (RAN), the CU defining a first node in the RAN, the method comprising: receiving, by processing hardware, a first message from a core network or another base station, the message including downlink data for a UE, when the UE is not operating in a connected state of a protocol associated with controlling radio resources;

determining, by the processing hardware, based on the first message, whether to include an indication of a voice call in a second message addressed to a second node in the RAN; and transmitting, by the processing hardware to the second node, the second message.

Example 12. The method of example 11, the determining includes: including the indication of voice call in the second message when the first message arrives from a core network (CN) and is associated with a control plane.

Example 13. The method of example 11, the determining includes: including the indication of voice call in the second message when the first message arrives from a peer base station or a CN and includes the indication of the voice call.

Example 14. The method of example 11, the determining includes: including the indication of voice call in the second message when the first message arrives from a CN over a certain tunnel.

Example 15. The method of example 11, the determining includes: including the indication of voice call in the second message when the first message is associated with a particular flow identifier.

Example 16. The method of example 15, wherein the flow identifier identifies a Quality-of-Service (QOS) flow.

Example 17. The method of example 11, wherein: the first message is received from a first CN; and the determining includes: including the indication of voice call in the second message when the UE is attached to a second CN.

Example 18. The method of any of examples 12-17, wherein the second node is a DU of the distributed base station.

Example 19. The method of any of examples 14-17, wherein the second node is a peer base station.

Example 20. The method of any of examples 12-17, further comprising: in response to determining to omit the indication of the voice call from the second message, transmitting the second message to least one more node in addition to the second node.

Example 21. The method of any of examples 11 or 14-20, wherein: the receiving and the determining are implemented at a user plane of the CU (CU-UP).

Example 22. The method of example 11 or 13, wherein: the receiving and the determining are implemented at a control plane of the CU (CU-CP).

Example 23. The method of example 11, wherein the first message is an NG Application Protocol (NGAP) paging message.

Example 24. The method of example 11, wherein the first message is an S1AP paging message.

Example 25. A method in core network (CN), the method comprising: receiving, by processing hardware, a first message including downlink data for a UE; determining, by the processing hardware and based on at least one of (i) the first message, (ii) capability of the UE, (iii) connectivity of the UE, or (iv) capability of a base station, whether to indicate a voice call in a second message; and transmitting by the processing hardware, the second message indicating a voice call to a base station, for paging the UE.

Example 26. The method of example 25, wherein the determining includes: indicating the voice call in the second message when the first message arrives from an IMS network.

Example 27. The method of example 25, wherein the determining includes: indicating the voice call in the second message when the first message arrives over a particular tunnel.

Example 28. The method of example 25, wherein the determining includes: indicating the voice call in the second message when the UE is attached to a second CN.

Example 29. The method of example 25, wherein the determining includes: indicating the voice call in the second message when the UE supports voice indication in a paging message.

Example 30. The method of example 25, wherein the determining includes: indicating the voice call in the second message when the base station supports voice indication in a CN-to-BS message.

Example 31. The method of any of examples 25-30, wherein the first message is a SIP INVITE message.

Example 32. The method of any of examples 25-30, wherein the first message is a paging request message received from a second CN.

Example 33. A method in a UE for notifying a second core network (CN) of communication availability in view of communication with a first CN, the method comprising: determining, by processing hardware, to establish a communication with the first CN; transmitting, by processing hardware, a first message to the second CN, to indicate that the UE is temporarily unable to communicate with the second CN; subsequently to disconnecting from the first CN, transmitting a second message to the second CN, to the indicate that the UE can communicate with the second CN.

Example 34. An electronic device including one or more processors and configured to implement a method according to any of the preceding examples.

1. A method, implemented in a distributed unit (DU) of a distributed base station, for paging a user equipment (UE), the method comprising:
receiving, from a central unit (CU) of the distributed base station and when the UE is not operating in a connected state of a protocol associated with controlling radio resources, a CU-to-DU message related to the UE and indicating a voice call; and
transmitting, to the UE via a radio interface, a paging message including an indication of the voice call.

2. The method of claim 1, further comprising:
generating the paging message at the DU, based on the CU-to-DU message.

3. The method of claim 1, wherein:
the CU-to-DU message includes a voice indication field.

4. The method of claim 1, wherein the CU-to-DU message includes a circuit-switched (CS) domain indicator field.

5. The method of claim 4, wherein transmitting the indication of the voice call includes transmitting the CS domain indicator field.

6. A method for paging a UE, implemented in a central unit (CU) of a distributed base station operating in a radio access network (RAN), the CU defining a first node in the RAN, the method comprising:
receiving a first message from a core network or another base station, the message including downlink data for a UE, when the UE is not operating in a connected state of a protocol associated with controlling radio resources;
determining based on the first message, whether to include an indication of a voice call in a second message addressed to a second node in the RAN; and
transmitting, to the second node, the second message.

7. The method of claim 6, the determining includes:
including the indication of voice call in the second message when the first message arrives from a core network (CN) and is associated with a control plane.

8. The method of claim 6, the determining includes:
including the indication of voice call in the second message when the first message arrives from a peer base station or a CN and includes the indication of the voice call.

9. The method of claim 6, the determining includes:
including the indication of voice call in the second message when the first message arrives from a CN over a certain tunnel.

10. The method of claim 6, the determining includes:
including the indication of voice call in the second message when the first message is associated with a particular flow identifier.

11. The method of claim 6, wherein:
the first message is received from a first CN; and
the determining includes:
including the indication of voice call in the second message when the UE is attached to a second CN.

12-14. (canceled)

15. A distributed unit (DU) of a distributed base station, the DU including one or more processors and configured to page a user equipment (UE), the DU configured to:
receive, from a central unit (CU) of the distributed base station and when the UE is not operating in a connected state of a protocol associated with controlling radio resources, a CU-to-DU message related to the UE and indicating a voice call; and
transmit, to the UE via a radio interface, a paging message including an indication of the voice call.

16. The DU of claim 15, further configured to:
generate the paging message at the DU, based on the CU-to-DU message.

17. The DU of claim 15, wherein:
the CU-to-DU message includes a voice indication field.

18. The DU of claim 15, wherein the CU-to-DU message includes a circuit-switched (CS) domain indicator field.

19. The DU of claim 18, wherein to transmit the indication of the voice call, the DU is configured to transmit the CS domain indicator field.
